(19) United States
(12) Patent Application Publication
(10) Pub. No.: US 2012/0065954 A1
(43) Pub. Date: Mar. 15, 2012

(54) METHODS OF MODELING A TRANSMITTER-RECEIVER SYSTEM AND RELATED METHODS OF DESIGNING A TRANSMITTER-RECEIVER SYSTEM

(75) Inventor: Woo-Jin Jin, Seoul (KR)

(73) Assignee: SAMSUNG ELECTRONICS CO., LTD., Suwon-si (KR)

(21) Appl. No.: 13/232,004

(22) Filed: Sep. 14, 2011

(30) Foreign Application Priority Data
Sep. 14, 2010 (KR) 10-2010-0089800

(51) Int. Cl. G06F 17/50

(52) U.S. Cl. 703/13

(57) ABSTRACT

A transmitter-receiver system is modeled by representing an output driver connected to an output node of a transmitter with a capacitive characteristic at the output node, representing a receiving buffer connected to an input node of a receiver, and representing a transmission path between the output node of the transmitter and the input node of the receiver.

### CROSS-REFERENCE TO RELATED APPLICATIONS

This application claims priority under 35 USC §119 to Korean Patent Application No. 10-2010-0089800 filed on Sep. 14, 2010, the disclosure of which is hereby incorporated by reference in its entirety.

### BACKGROUND OF THE INVENTION

Embodiments of the inventive concept relate generally to signal transmission. More particularly, embodiments of the inventive concept relate to methods of modeling a transmitter-receiver system and methods of designing a transmitter-receiver system.

Chip-to-chip interfaces have been developed to support high speed operation of about 400 MHz. In addition, interfaces capable of operating in 533 MHz are currently under development. It is expected that the operation speed of the chip-to-chip interfaces will be further increased.

The transmission characteristics of chip-to-chip interfaces can be analyzed using an eye diagram. For many consumer applications, the analysis of the eye diagram must meet standards regulated by Joint Electron Device Engineering Council (JEDEC). For example, an eye diagram of transmitted signals must meet standards such as overshoot, undershoot, and ringback.

To achieve a required eye diagram, a designer may select a driver size having suitable driver strength, or the designer may change the package design repeatedly to obtain appropriate design values until the required eye diagram appears. On the other hand, the rising time and/or falling time of a signal to be transferred may be changed in system design to suppress noise. Such processes are more difficult if the system operates in high speed, because the rising/falling time must be decreased to obtain sufficient eye opening or eye size even though the period of signal decreases. As the rising/falling time decreases, noise tends to increase accordingly.

### SUMMARY OF THE INVENTION

According to one embodiment of the inventive concept, a method of modeling a transmitter-receiver system comprises modeling an output driver connected to an output node of a transmitter as comprising a capacitive characteristic at the output node of the transmitter, modeling a receiving buffer connected to an input node of a receiver, and modeling a transmission path between the output node of the transmitter and the input node of the receiver.

According to another embodiment of the inventive concept, a method of designing a transmitter-receiver system comprises modeling a transmitter-receiver system with a capacitive characteristic at an output node of a transmitter, measuring a transmission characteristic of the transmitter-receiver system with different variables of the model, and determining design values of the variables of the model based on measured values of the transmission characteristic.

According to another embodiment of the inventive concept, a method of designing a transmitter-receiver system comprising a chip-to-chip interface associated with first and second chips comprises modeling an output driver connected to an output node of a transmitter of the first chip as comprising a capacitive characteristic at the output node of the transmitter, modeling a receiving buffer connected to an input node of a receiver of the second chip, and modeling a transmission path between the output node of the transmitter and the input node of the receiver.

These and other embodiments of the inventive concept can improve the transmission characteristics of transmitter-receiver systems, for example, by reducing noise.

### BRIEF DESCRIPTION OF THE DRAWINGS

The drawings illustrate non-exhaustive and non-limiting embodiments of the inventive concept. In the drawings, like reference numbers indicate like features. In addition, the relative dimensions of certain features shown in the drawings may be exaggerated for clarity of illustration.

FIG. 1 is a flowchart illustrating a method of modeling a transmitter-receiver system according to an embodiment of the inventive concept.

FIG. 2 is a block diagram illustrating a transmitter-receiver system to be modeled according to an embodiment of the inventive concept.

FIG. 3 is a diagram illustrating an equivalent circuit of the transmitter-receiver system of FIG. 2 according to an embodiment of the inventive concept.

FIG. 4 is a block diagram illustrating a bilateral transmitter-receiver system according to an embodiment of the inventive concept.

FIG. 5 is a circuit diagram illustrating an example of an output driver shown in FIG. 4.

FIGS. 6 and 7 are diagrams for describing a method of determining a resistance of a source resistor according to an embodiment of the inventive concept.

FIG. 8 is a diagram for describing a method of determining a capacitance of a source capacitor according to an embodiment of the inventive concept.

FIG. 9 is a graph illustrating an effect of a method of modeling a transmitter-receiver system according to an embodiment of the inventive concept.

FIG. 10 is a flowchart illustrating a method of designing a transmitter-receiver system according to an embodiment of the inventive concept.

FIGS. 11 and 12 are graphs illustrating example transmission characteristics measured during the design of a transmitter-receiver system according to embodiments of the inventive concept.

FIGS. 13 and 14 are block diagrams illustrating transmitter-receiver systems with different package types according to embodiments of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms first, second, third, etc. are used to distinguish between different features. The described features, however, should not be limited by these terms. For example, a first feature discussed below could be termed a second feature without departing from the described embodiments. As used herein, the term “and/or” encompasses any and all combinations of one or more of the associated listed items.

Where a feature is referred to as being “connected” or “coupled” to another feature, it can be directly connected or coupled to the other feature, or intervening features may be present. In contrast, where a feature is referred to as being “directly connected” or “directly coupled” to another feature, there are no intervening features present. Other words used to describe the relationship between features should be interpreted in a similar fashion (e.g., “between” versus “directly between,” “adjacent” versus “directly adjacent,” etc.).

The terminology used herein is for the purpose of describing particular embodiments and is not intended to limit the inventive concept. As used herein, the singular forms “a,” “an” and “the” are intended to encompass plural forms as well, unless the context clearly indicates otherwise. The terms “comprises” and/or “comprising,” when used in this specification, indicate the presence of stated features, but they do not preclude additional features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and should not be interpreted in an idealized or overly formal sense unless expressly so defined herein.

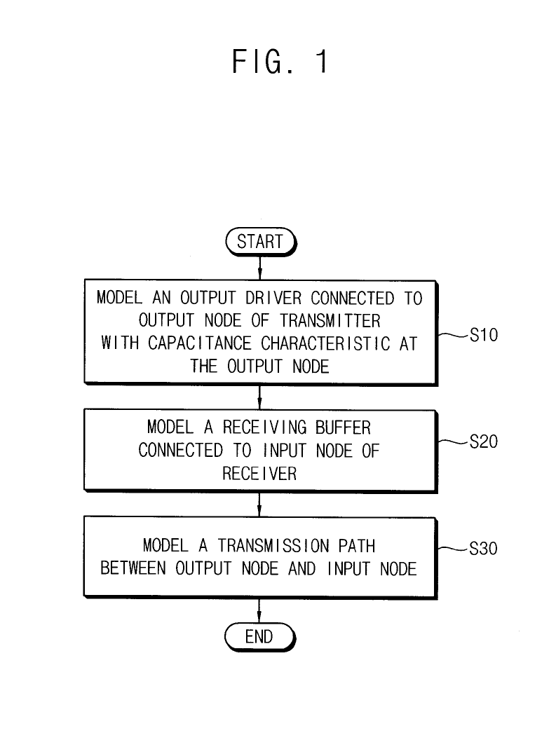

FIG. 1 is a flowchart illustrating a method of modeling a transmitter-receiver system according to an embodiment of the inventive concept.

Referring to FIG. 1, an output driver connected to an output node of a transmitter is modeled with a capacitive characteristic at the output node (S10). In this context, modeling comprises forming a representation of device characteristics, for example, by a mathematical model, a virtual simulation, or some other form. A receiving buffer connected to an input node of a receiver is modeled (S20), and a transmission path between the output node of the transmitter and the input node of the receiver is modeled (S30).

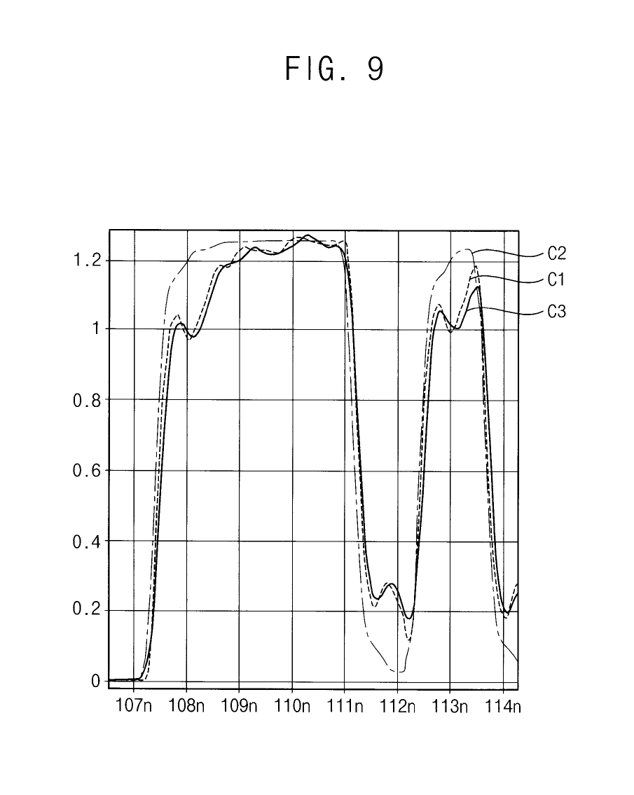

The modeling of the output driver, the receiving buffer, and the transmission path can be performed in arbitrary order, or they may be performed in parallel. As described below, the output driver can be modeled to include the capacitive characteristic at the output node by determining a capacitance affecting the driving operation of the output driver. The method of modeling the transmitter-receiver system of FIG. 1 will be described below with reference to FIGS. 2 and 9.

FIG. 2 is a block diagram illustrating a transmitter-receiver system to be modeled according to an embodiment of the inventive concept.

Referring to FIG. 2, a transmitter-receiver system 1000 comprises a transmitter 110, a receiver 130, and a transmission path 150. Transmitter 110 comprises an output driver 111, and receiver 130 comprises a receiving buffer 131. Output driver 111 and receiving buffer 131 can be combined with transmission path 150 through IO pads 113 and 133. Pad 113 of transmitter 110 corresponds to the output node of transmitter 110, and pad 133 of receiver 130 corresponds to the input node of receiver 130. Other internal circuits of transmitter 110 and receiver 130 are omitted from FIG. 2 in order to focus on the illustrated features.

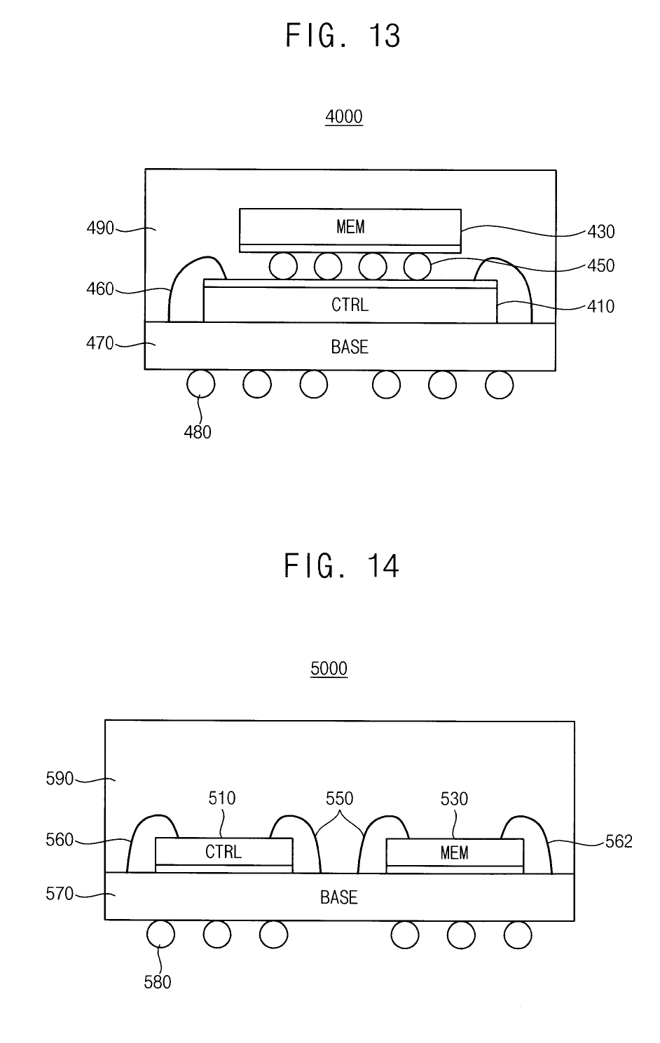

Transmission path 150 can include any type of transmission medium, such as wires and bus systems implemented on a printed circuit board (PCB). As depicted, for instance, in FIGS. 13 and 14, transmission path 150 can include bumps such as solder balls, a through silicon via (TSV), and wires.

Output driver 111 operates output node 113 connected to transmission path 150 based on an internal transmission signal TD. Receiving buffer 131 detects a voltage on input node 133 of receiver 130, which is connected to transmission path 150, to generate internal receiving signal RD.

In conventional transmitter-receiver system modeling, the output driver is modeled using only a source resistance, without the capacitive characteristic at the output node. As described below with reference to FIG. 9, a curve C2 resulting from these modeling technologies may not accurately reflect actual transmission characteristics.

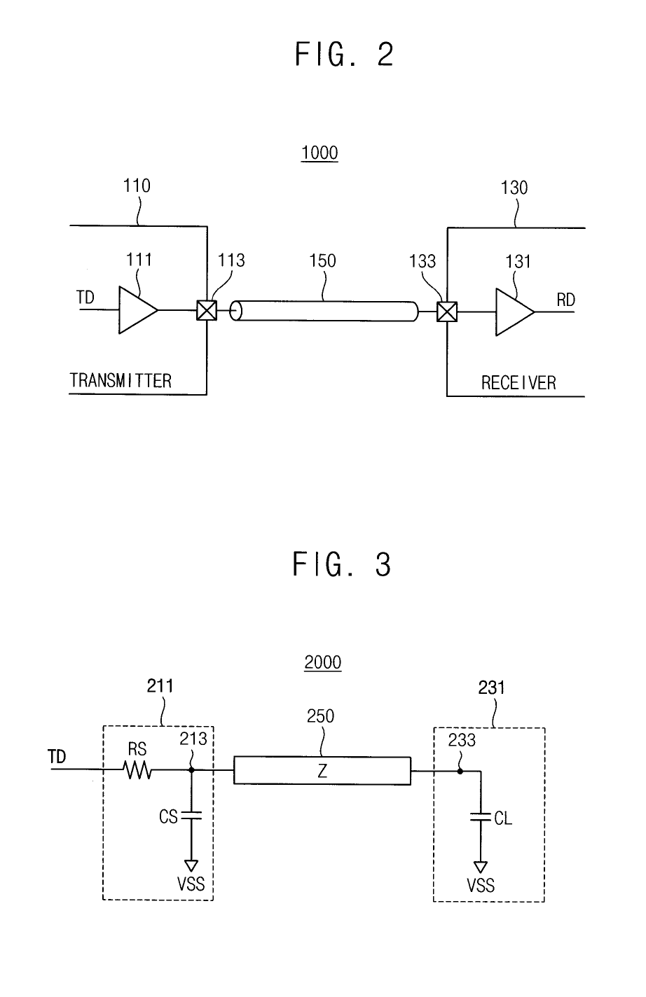

FIG. 3 is a diagram illustrating an equivalent circuit of the transmitter-receiver system of FIG. 2 according to an embodiment of the inventive concept.

Referring to FIG. 3, transmitter-receiver system 1000 is represented by a transmitter-receiver system 2000 comprising a transmitter 211, a receiving buffer 231, and a transmission path 250. In transmitter-receiver system 2000, transmitter 110 is represented by a transmitter 211, receiver 130 is represented by a receiver 231, and transmission path 150 is represented by a transmission path 250.

Output driver 211 comprises a source resistor RS and a source capacitor CS. Source resistor RS is connected to an output node 213 of transmitter 211, and source capacitor CS is connected between output node 233 and a ground voltage VSS. Transmission path 250 is modeled by a transmission line having a corresponding impedance Z. Receiver 231 comprises a load capacitor CL connected between an input node 233 of receiver 231 and ground voltage VSS.

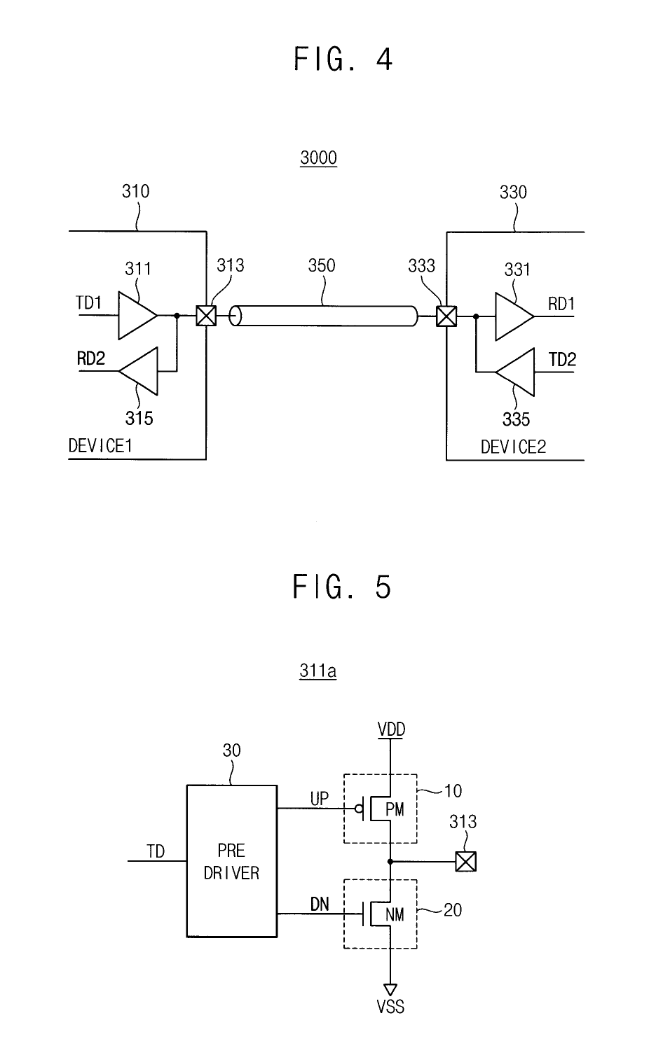

Example resistance values of source resistor RS, capacitance values of source capacitor CS, and capacitance values of load capacitor CL are described below with reference to FIGS. 5 and 8.

By modeling transmitter 211 with the capacitive characteristic at output node 213, improved transmitter-receiver systems can be designed.

FIG. 4 is a block diagram illustrating a bilateral transmitter-receiver system.

Referring to FIG. 4, transmitter-receiver system 3000 comprises a first device (DEVICE 1) 310, a second device (DEVICE 2) 330, and a transmission path 350. A pad 313 of first device 310 and a pad 333 of second device 330 are connected to opposite sides of transmission path 350.

Unlike transmitter-receiver system 1000, which is unilateral, transmitter-receiver system 3000 is bilateral. For bilateral transmission, first device 310 comprises a first output driver 311 and a first receiving buffer 315. In addition, second device 330 comprises a second receiving buffer 331 and a second output driver 335. In some embodiments, first device 310 and second device 330 are implemented in different chips. In addition, transmitter-receiver system 3000 can be implemented in a package. For example, one of first device 310 and second device 330 can be a memory chip, and the other can be a controller chip. In this case, transmission path 350 may be a memory bus.

Where signals are transmitted from first device 310 to second device 330, first output driver 311 of first device 310 and second receiving buffer 331 of second device 330 are enabled, and first receiving buffer 315 of first device 310 and second output driver 335 of second device 330 are disabled. In this case, pad 313 of first device 310 corresponds to the output node of the transmitter, and pad 333 of second device 330 corresponds to the input node of the receiver. First output driver 311 operates pad 313 connected to transmission path 350 based on an internal transmission signal TD1. Second receiving buffer 331 detects a voltage on pad 333, which is connected to transmission path 350, to generate an internal receiving signal RD1.

In contrast, where signals are transmitted from second device 330 to first device 310, first receiving buffer 315 of first device 310 and second output driver 335 of second device 330 are enabled, and first output driver 311 of first device 310 and second receiving buffer 331 of second device 330 are disabled. In this case, pad 313 of first device 310 corresponds to the input node of the receiver, and pad 333 of second device 330 corresponds to the output node of the transmitter. Second output driver 335 operates pad 333 connected to transmission path 350 based on an internal transmission signal TD2. First receiving buffer 315 detects a voltage on pad 313, which is connected to transmission path 350, to generate an internal receiving signal RD2.

The equivalent circuit diagram of FIG. 3 can also be used in the bilateral transmitter-receiver system 3000 of FIG. 4.

Where a signal is transmitted from first device 310 to second device 330, the resistance of the source resistor and the capacitance of the source capacitor in first output driver 311 can be obtained by using the equivalent circuit of FIG. 3. The capacitance of the load capacitor in second receiving buffer 331 can also be obtained using the equivalent circuit of FIG. 3. In contrast, where a signal is transmitted from second device 330 to first device 310, the resistance of the source resistor and the capacitance of the source capacitor in second output driver 335 can be obtained by using the equivalent circuit of FIG. 3. The capacitance of the load capacitor in first receiving buffer 315 can also be obtained using the equivalent circuit of FIG. 3.

In each transmission mode, disabled elements can be reflected in modeling variables of enabled elements. For example, where first device 310 functions as the transmitter and first output driver 311 controls pad 313, the parasitic capacitance of first receiving buffer 315 affects the capacitance of the source capacitor in the model of first output driver 311.

Various internal circuits of first device 310 and second device 330 are omitted from FIG. 4 in order to focus on output drivers 311, 335 and receiving buffers 315, 331. Transmission path 350 can comprise various types of transmission technologies such as wirings and bus systems on a PCB. As depicted in FIGS. 13 and 14, transmission path 150 can comprise technologies such as a solder ball, or a TSV.

FIG. 5 is a circuit diagram illustrating an example of output driver 311 of FIG. 4.

Referring to FIG. 5, an output driver 311a comprises a pull-up unit 10, a pull-down unit 20 and a pre-driver 30.

Pre-driver 30 generates a pull-up driving signal UP and a pull-down driving signal DN based on internal transmission signal TD. For alternating switching operations of pull-up unit 10 and pull-down unit 20, pull-up signal UP and pull-down signal DN may comprise appropriate logic levels. In addition, falling timing and rising timing of pull-up signal UP and pull-down signal DN can be controlled by pre-driver 30. For example, one of the transition timings of pull-up signal UP and pull down signal DN to prevent pull-up unit 10 and pull-down unit 20 from being turned on simultaneously, which causes short current between power-supply voltage VDD and ground voltage VSS.

Pull-up unit 10 comprises a p-channel metal oxide semiconductor (PMOS) transistor PM connected between power-supply voltage VDD and an output node 313, and pull-down unit 20 comprises an n-channel metal oxide semiconductor (NMOS) transistor NM connected between ground voltage VSS and output node 313.

Where internal transmission signal TD changes from a logic low level to a logic high level, PMOS transistor PM is turned on in response to pull-up signal UP, and NMOS transistor NM is turned off in response to pull-down signal DN. Then output node 313 rises to the logic high level. In contrast, where internal transmission signal TD changes from the logic high level to the logic low level, PMOS transistor PM is turned off in response to pull-up signal UP, and NMOS transistor NM is turned on in response to pull-down signal DN. Then output node 313 drops to the logic low level.

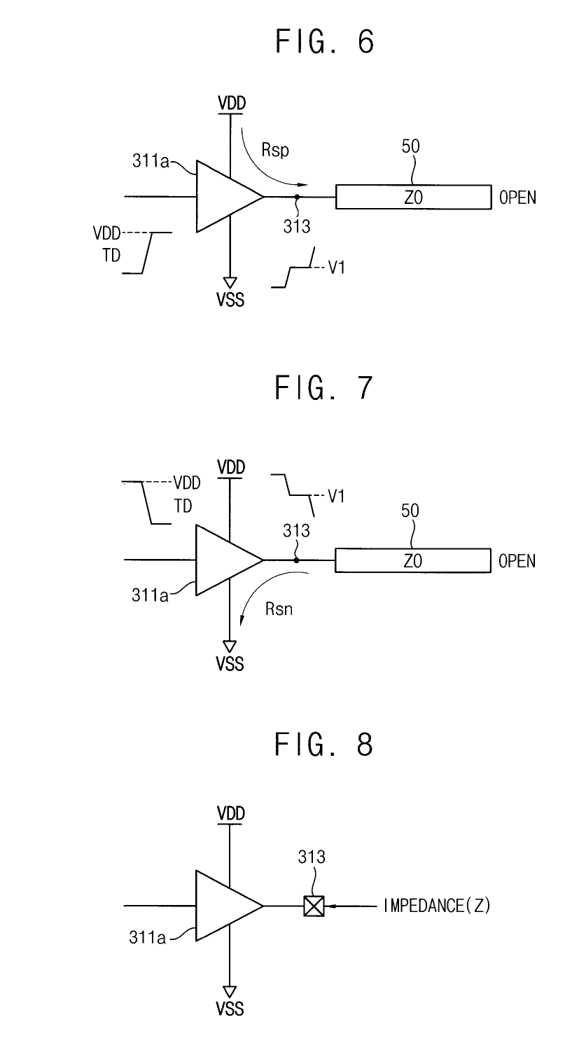

FIGS. 6 and 7 are diagrams for describing a method of determining a resistance of a source resistor according to an embodiment of the inventive concept. The method of FIGS. 6 and 7 can be used to determine resistance RS of source resistor RS in FIG. 3.

The method of FIG. 6 is used to determine a first resistance Rsp of the pull-up resistor, which is between the power supply voltage VDD of output driver 311a and output node 313. The method of FIG. 7 is used to determine a second resistance Rsn of the pull-down resistor, which is between the ground voltage VSS of output driver 311a and output node 313. Thereafter, an average of first resistance Rsp and second resistance Rsn is determined as resistance RS of source resistor RS.

Referring to FIG. 6, first resistance Rsp corresponds to a turn-on resistance of pull-up unit 10 of FIG. 5, which is turned on when internal transmission signal TD changes from the logic low level to the logic high level. Referring to FIG. 7, second resistance Rsn corresponds to a turn-on resistance of pull-down unit 20 in FIG. 5, which is turned on when internal transmission signal TD changes from the logic high level to the logic low level.

First resistance Rsp and second resistance Rsn can be determined as follows. First, a model of an open transmission line 50 is connected to output node 313. Transmission line 50 can be modeled by a known impedance value. Under these conditions, a stay voltage V1 of output node 313, which results from charge of open transmission line 50 during the pull-up operation of output driver 311a, is measured. In addition, stay voltage V1 of output node 313, which results from discharge of open transmission line 50 during the pull-down operation of output driver 311a, is measured. Two values of stay voltage V1 resulting form charge and discharge of open transmission line 50 are substantially identical to each other. Where the two values of stay voltage V1 are different from each other, an average of the two values can be chosen.

As described above, where stay voltage V1 is determined by measurements or simulations, first resistance Rsp and second resistance Rsn can be calculated by following expressions (1) and (2), respectively.

Rsp=Z0{(VDD/V1)−1} (1)

Rsn=Z0{V1/(VDD−1)} (2)

In expressions (1) and (2), ‘Rsp’ and ‘Rsn’ represent the first resistance the second resistances, ‘Z0’ represents the impedance of open transmission line 50. ‘VDD’ represents power supply voltage of output driver 311a, and ‘V1’ represents the stay voltage of output node 313 during the pull-up operation and the pull-down operation of output driver 311a.

To calculate first resistance Rsp corresponding to a rising signal and second resistance Rsn corresponding to a falling signal, stay voltage V1 can be measured or simulated by connecting the model of open transmission line 50 having the known impedance to output node 313. First resistance Rsp and second resistance Rsn can have similar values, and the average of the two values can be determined as resistance RS of the source resistor.

FIG. 8 is a diagram for describing a method of determining a capacitance of a source capacitor according to an embodiment of the inventive concept. The method of FIG. 8 can be used, for example to determine source capacitance CS in the model of FIG. 3. To determine capacitance CS, the impedance at output node 313 can be extracted by performing alternating-current (AC) analysis in the frequency domain.

Here, AC analysis is performed when output driver 311a is disabled. In FIG. 5, for example, pull-up signal UP and pull-down signal DN may respectively maintain the logic high level and the logic low level to turn off PMOS transistor PM and NMOS transistor NM, in order to disable output driver 311a. In this situation, output node 313 maintains a floating condition. Although the capacitance CS of the source capacitor is a model of output driver 311a, the impedance of output node 313 must be extracted while output driver 311a is disabled and first device 310 operates in receiving mode.

As described above, the impedance of output node 313 can be extracted while output driver 311a is disabled. In this case, capacitance CS of the source capacitor can be calculated by following expression (3).

CS=1/{2πFIm(Z1)} (3)

In expression (3), ‘CS’ represents the capacitance of the source capacitor, and ‘F’ represents the operation frequency of the AC analysis. In addition, ‘Im(Z1)’ represents the imaginary part of the impedance extracted at output node 313.

Although not described in figures, load capacitance CL of FIG. 3 can be determined similar to source capacitance CS. In other words, the impedance at input node 333 can be extracted by performing the AC analysis in the frequency domain. Load capacitance CL can be determined by extracting the impedance at input node 333 of the receiver.

After the impedance at input node 333 is determined, load capacitance CL can be calculated by following expression (4).

CL=1/{2πFIm(Z2)} (4)

In expression (4), ‘CL’ represents the capacitance of the load capacitor, and ‘F’ represents the operation frequency of the AC analysis. In addition, ‘Im(Z1)’ represents the imaginary part of the impedance extracted at output node 313.

FIG. 9 is a graph illustrating an effect of a method of modeling a transmitter-receiver system according to embodiments of the inventive concept.

In FIG. 9, a curve C1 represents a signal transmitted in actual transmitter-receiver systems, and a curve C2 represents a signal transmitted using a conventional model. In addition, a curve C3 represents a signal transmitted using a model according to an embodiment of the inventive concept, where an output driver connected to an output node of a transmitter is modeled with a capacitive characteristic at the output node. In FIG. 9, the vertical axis represents the voltage at the input node of the receiver, and the horizontal axis represents time.

In the conventional model corresponding to curve C2, an output driver is modeled using only a source resistor and excluding a capacitive characteristic at an output node. As indicated by curve C2, the model does not accurately reflect the actual transmission characteristics shown in curve C1. In contrast, the model of FIG. 3, which corresponds to curve C3, is very close to curve C1. Accordingly, the model of FIG. 3 accurately reflects actual transmission characteristics.

In a conventional transmitter-receiver system, a signal waveform is measured at an input node of a receiving part based on inaccurate modeling to obtain an eye diagram, and then the designer checks whether the eye diagram meets the required design standards. Where the eye diagram does not meet the standards, the size of the output driver is changed, or the design is changed so that slew rate of the output driver is decreased to reduce noise. The design may be changed repeatedly until the eye diagram, which meets the standard requirement, is obtained. Because the design process described above is performed without determining accurate design points, the working time for transmitter-receiver system design increases, and the modeled transmitter-receiver system provides poor performance.

The method of modeling a transmitter-receiver system according to an embodiment of the inventive concept can be used in designing a high performance transmitter-receiver system, by modeling the output driver with capacitive characteristic at the output node of the transmitter.

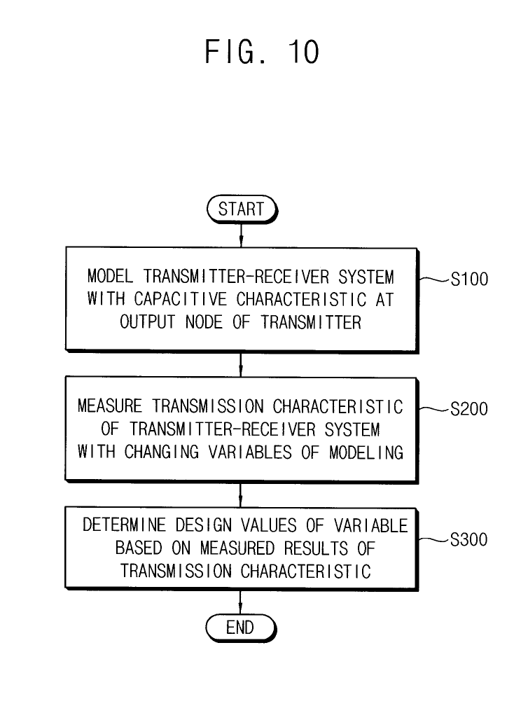

FIG. 10 is a flowchart illustrating a method of designing a transmitter-receiver system according to an embodiment of the inventive concept.

Referring to FIG. 10, a transmitter-receiver system is modeled with a capacitive characteristic at the output node of a transmitter (S100). After the transmitter-receiver system is modeled, a transmission characteristic is measured with changing variables of the modeling (S200). Design values of the model are determined based on the measured transmission characteristic (S300).

As described above with reference to FIGS. 1 and 9, an output driver connected to an output node is modeled with a capacitive characteristic at the output node of a transmitter, a receiving buffer connected to an input node of a receiver is modeled, and a transmission path between the output node of the transmitter and the input node of the receiver is modeled. To model the output driver, a source resistor connected to the output node of the transmitter may be modeled, and the source capacitor connected between the output node and a ground node of the receiver may be modeled. Using the method of FIG. 10, an optimized design point can be obtained by appropriate modeling.

Here, a first resistance of a pull-up resistor between power-supply voltage and the output node of the output driver may be determined, and a second resistance of a pull-down resistor between ground voltage and the output node of the output driver may be determined. Consequently, the average of the first resistance and the second resistance may be determined as the resistance of the source resistor. In addition, to determine the capacitance of the source capacitor, the impedance at the output node of the transmitter can be extracted by performing AC analysis in the frequency domain. Similarly, to determine the capacitance of the load capacitor, the impedance at the input node of the receiver may be extracted by performing AC analysis in the frequency domain.

In this modeling method, the modeling variables for measuring transmission characteristics of the transmitter-receiver system comprise source resistance RS of the source resistor and source capacitance CS of the source capacitor, which are from the model of the output driver. In addition, the modeling variables may also comprise load capacitance CL of the load capacitor, which is from the model of the receiving buffer.

As described above, the transmission characteristic of the transmitter-receiver system can be measured by measuring the eye-size of the transmission signal output by the transmitter, at the input node of the receiver.

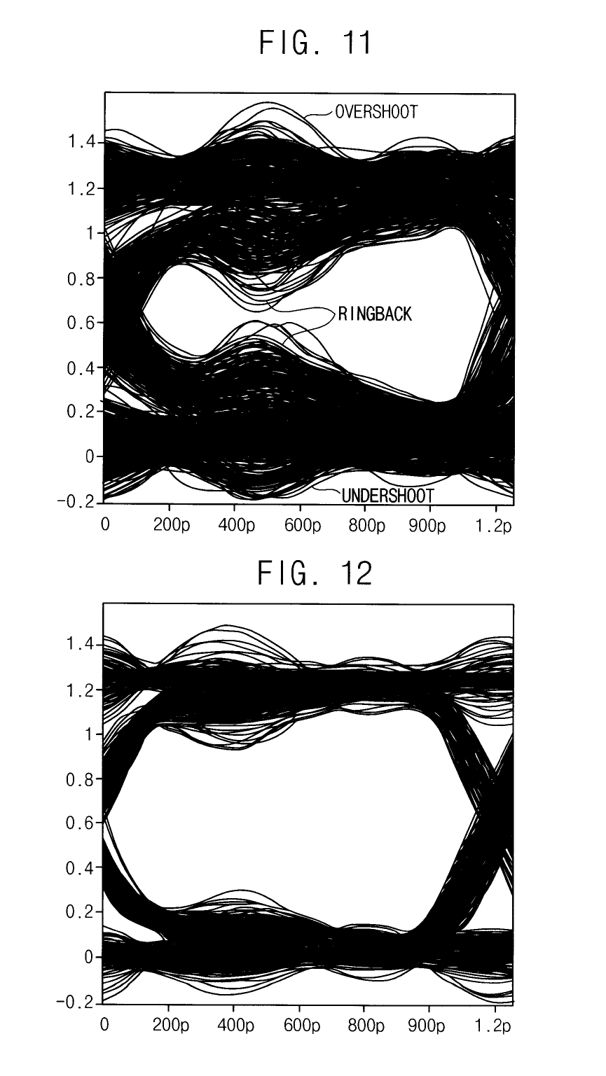

FIGS. 11 and 12 are graphs illustrating examples of transmission characteristics measured during designing of a transmitter-receiver system according to an embodiment of the inventive concept. In particular, FIG. 11 illustrates an eye-diagram where the transmission characteristics are inadequately modeled, and FIG. 12 illustrates an eye-diagram where the transmission characteristic is modeled according to an embodiment of the inventive concept.

Referring to FIG. 11, where inappropriate modeling variables are chosen, noise occurs, such as overshooting, undershooting, and ringback. In addition, a skew is about 202 pico-second(ps), and an eye-size is about 490 ps, which constitute poor transmission characteristics. In contrast, referring to FIG. 12, where the appropriate modeling variables are chosen, noise such as overshooting, undershooting, and ringback is decreased remarkably. In addition, skew is decreased to about 123 ps, and the eye-size is increased to 1030 ps, which constitute better transmission characteristics.

As described above, an appropriate design point, i.e. an adequate model type and modeling variables can be obtained to model the transmitter-receiver system. Consequently, a design period may be shortened, and the performance of the transmitter-receiver system may be enhanced.

FIGS. 13 and 14 are block diagrams illustrating transmitter-receiver systems having different package types according to embodiments of the inventive concept. Transmitter-receiver systems such as these can be modeled according to various embodiments of the inventive concept.

As depicted in FIGS. 13 and 14, transmitter-receiver systems such as those illustrated in FIGS. 2 and 4 can be implemented in system-in-package (SIP) form. For example, first device 310 and second device 330 of FIG. 4 can take the form of a controller chip 410 and a memory chip 430 in FIG. 13, respectively. Alternatively, first device 310 and second device 330 in FIG. 4 can take the form of a controller chip 510 and a memory chip 530 in FIG. 14, respectively.

Referring to FIG. 13, a package 4000 comprises a base substrate (BASE) 470, a controller chip (CTRL) 410 positioned above base substrate 470, and at least one semiconductor memory chip (MEM) 430 positioned above controller chip 410. Base substrate 470 typically comprises a PCB, and controller chip 410 typically comprises a microprocessor unit (MPU). After the chips are stacked, resin or a suitable alternative is formed on a top part of package 4000. Semiconductor memory chip 430 is electrically connected to controller chip 410 via input/output (I/O) bumps 450, and controller chip 410 and base substrate 470 are electrically via bonding wires 460. Bumps 480, which are used for electric connection to external devices, are formed under base substrate 470. In the package form of FIG. 13, controller chip 410 and memory chip 430 are directly and electrically connected each other without passing the wires in base substrate 470.

Referring to FIG. 14, a package 5000 comprises a base substrate (BASE) 570, a controller chip (CTRL) 510 positioned above base substrate 470, and at least one semiconductor memory chip (MEM) 530. Base substrate 570 typically comprises a PCB, controller chip 510 and memory chip 530 are electrically connected to base substrate 570 via bonding wires 550, 560, 562. In other words, controller chip 510 and memory chip 530 are electrically connected each by passing wires through base substrate 570.

As depicted in FIGS. 13 and 14, transmitter-receiver systems can be implemented in various forms, so the characteristics of transmission paths 150 and 350 in FIGS. 2 and 4 can be variously configured according to the different forms. The transmission paths can take various forms such as the wirings of a PCB or a bus system. Where the transmitter-receiver system is implemented in a package form, such as those depicted in FIGS. 13 and 14, transmission paths 150, 350 may comprise bump 450 in the form of a solder ball or through-silicon via wires 550.

As indicated by the foregoing, a transmitter-receiver model takes account of capacitive characteristics at an output node of a transmitter. The model can improve the design of various transmitter-receiver structures, such as chip-to-chip interfaces used in high frequency applications. In addition, the above-described modeling and design methods can be used in development of any system that transmits and receives signals, especially those requiring high speed interfaces.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of modeling a transmitter-receiver system, comprising:
modeling an output driver connected to an output node of a transmitter as comprising a capacitive characteristic at the output node of the transmitter;
modeling a receiving buffer connected to an input node of a receiver; and
modeling a transmission path between the output node of the transmitter and the input node of the receiver.

2. The method of claim 1, wherein modeling the output driver comprises representing the output driver with one resistor and one capacitor.

3. The method of claim 1, wherein modeling the output driver comprises:
representing a source resistor connected to the output node of the transmitter; and
representing a source capacitor connected between the output node of the transmitter and a ground voltage.

4. The method of claim 3, wherein representing the source resistor comprises:
determining a first resistance of a pull-up resistor between a power-supply voltage of the output driver and the output node;
determining a second resistance of a pull-down resistor between the ground voltage and the output node; and
determining a source resistance of the source resistor by taking an average of the first resistance and the second resistance.

5. The method of claim 4, wherein determining the first resistance and determining the second resistance comprises:
combining a model of an open transmission line with a model of the output node; and
measuring a stay voltage of the output node according to a charge and a discharge of the open transmission line during a pull-up operation and a pull-down operation of the output driver.

6. The method of claim 5, wherein the first resistance is determined by a relationship Rsp=Z0{(VDD/V1)−1}, and the second resistance is determined by a relationship Rsn=Z0{V1/(VDD−1)}, where, Rsp represents the first resistance, Rsn represents the second resistance, Z0 represents an impedance of the open transmission line, VDD represents the power-supply voltage of the output driver, and V1 represents the stay voltage of the output node during the pull-up operation and the pull-down operation of the output driver.

7. The method of claim 3, wherein representing the source capacitor comprises:
extracting an impedance at the output node by performing an alternating-current (AC) analysis in the frequency domain.

8. The method of claim 7, wherein the AC analysis is performed when the output driver is disabled.

9. The method of claim 8, wherein a capacitance of the source capacitor is represented by a relationship CS=1/{2πFIm(Z1)}, wherein CS represents the capacitance of the source capacitor, F represents an operating frequency of the AC analysis, and Im(Z1) represents an imaginary part of the impedance extracted at the output node.

10. The method of claim 1, wherein modeling the receiving buffer comprises representing a load capacitor connected between the input node and a ground voltage.

11. The method of claim 3, wherein representing the source capacitor comprises:
extracting an impedance at the input node by performing an alternating-current (AC) analysis in the frequency domain.

12. The method of claim 8, wherein a capacitance of the load capacitor is represented by a relationship CL=1/{2πFIm(Z2)}, wherein CL represents the capacitance of the load capacitor, F represents an operating frequency of the AC analysis, and Im(Z2) represents an imaginary part of the impedance extracted at the input node.

13. A method of designing a transmitter-receiver system, comprising:
modeling a transmitter-receiver system with a capacitive characteristic at an output node of a transmitter;
measuring a transmission characteristic of the transmitter-receiver system with different variables of the model; and
determining design values of the variables of the model based on measured values of the transmission characteristic.

14. The method of claim 13, wherein modeling the transmitter-receiver system comprises:
modeling an output driver connected to the output node of the transmitter as comprising the capacitive characteristic at the output node of the transmitter;
modeling a receiving buffer connected to an input node of a receiver; and
modeling a transmission path between the output node of the transmitter and the input node of the receiver.

15. The method of claim 14, wherein modeling the output driver comprises:
representing a source resistor connected to the output node of the transmitter; and
representing a source capacitor connected between the output node of the transmitter and a ground voltage.

16. The method of claim 15, wherein representing the source resistor comprises:
determining a first resistance of a pull-up resistor between a power-supply voltage of the output driver and the output node;
determining a second resistance of a pull-down resistor between the ground voltage and the output node; and
determining a source resistance of the source resistor by taking an average of the first resistance and the second resistance.

17. The method of claim 15, wherein representing the source capacitor comprises:
extracting an impedance at the output node by performing an alternating-current (AC) analysis in the frequency domain to determine a capacitance of the source capacitor.

18. The method of claim 14, wherein measuring the transmission characteristic of the transmitter-receiver system comprises:
measuring an eye size of a transmission signal at the input node of the receiver, the transmission signal being transmitted through the transmission path from the transmitter.

19. A method of designing a transmitter-receiver system comprising a chip-to-chip interface associated with first and second chips, the method comprising:
modeling an output driver connected to an output node of a transmitter of the first chip as comprising a capacitive characteristic at the output node of the transmitter;
modeling a receiving buffer connected to an input node of a receiver of the second chip; and
modeling a transmission path between the output node of the transmitter and the input node of the receiver.

20. The method of claim 19, wherein modeling the output driver comprises representing the output driver with one resistor and one capacitor.
